(19) United States
(12) Patent Application Publication
(10) Pub. No.: US 2010/0078148 A1
(43) Pub. Date: Apr. 1, 2010

(54) Heat Exchanger Including At Least Three Heat Exchange Portions and Thermal Energy Management System Including Such Exchanger

(76) Inventors: Philippe Jouanny, Guyancourt (FR); Ngy Sru Ap, Saint Remy Les Chevreuse (FR); Jean-Sylvain Bernard, Les Mesnil-Saint-Denis (FR); Carlos Da Silva, Mareil Sur Mauldre (FR)

Correspondence Address: HOWARD & HOWARD ATTORNEYS PLLC, 450 West Fourth Street, Royal Oak, MI, 48067, US

(21) Appl. No.: 12/518,797

(22) PCT Filed: Nov. 15, 2007
(86) PCT No.: PCT/EP2007/062380

§ 371 Date: Dec. 3, 2009

(30) Foreign Application Priority Data
Dec. 14, 2006 (FR) 0610954

(51) Int. Cl. B60H 1/32; F28F 1/10; F28F 3/08

(52) U.S. Cl. 165/51; 165/181; 165/166

(57) ABSTRACT

The invention relates to a heat exchanger comprising at least a first, a second and a third heat-exchange portions (221; 222; 223) situated substantially in one and the same plane, said cluster allowing an independent circulation of fluid in each of said exchange portions (221; 222; 223).

The invention also relates to a system for managing the thermal energy developed by a motor vehicle engine comprising such a heat exchanger.

Application to the automotive field.

The invention relates to the field of heat exchangers, notably for motor vehicles.

Modern motor vehicles comprise, in addition to the heat engine, many items of equipment which exchange heat with an external environment, either in order to be cooled, or on the contrary to be heated. As an example, it is possible to cite the condenser of the air-conditioning circuit for the vehicle's passenger compartment, the turbocharging air cooler or else the radiator for heating the passenger compartment. That is why these vehicles are usually fitted with two circuits, namely a high-temperature circuit which is used for cooling the heat engine and items of equipment the temperature of which is highest, and a low-temperature cooling circuit which is used for cooling items of equipment the temperature of which is lower, such as, for example, the condenser of the air-conditioning circuit for the motor vehicle's passenger compartment. Each of these circuits is furnished with a cooling radiator for the extraction of the heat.

In the known vehicles, the exchange surface area of the radiator of the high-temperature loop and the exchange surface area of the low-temperature loop are fixed. In addition, the high-temperature radiator is used exclusively for cooling the items of equipment of the high-temperature circuit, while the low-temperature radiator is used exclusively for cooling and/or heating items of equipment of the low-temperature circuit. In certain engine-load circumstances, in particular at low load, it is not necessary to cool the heat engine. That is why the cooling liquid on the engine circulates through a branch pipe which bypasses the high-temperature radiator so that the cooling capacity of the latter is not used. There is therefore a loss of cooling capacity.

Notably through document FR 2 844 041, a heat-exchange module is known that comprises surface area distribution means which make it possible to split in a modulatable manner, the heat-exchange surface area into a high-temperature heat-exchange section used for cooling the high-temperature circuit and a low-temperature heat-exchange section used for cooling the low-temperature circuit. The surface area distribution means consist of adjustable partition means incorporated into the collector box, for example retractable partitions.

However, such a heat-exchange module comprises a certain number of disadvantages and notably a considerable space requirement at the collector boxes comprising the surface area partition means, difficulties in obtaining a perfect seal at these same partition means and considerable manufacturing costs.

The object of the present application is to improve the situation. Accordingly it proposes an exchanger comprising at least a first, a second and a third heat-exchange portions situated substantially in one and the same plane, and wherein the cluster allows an independent circulation of fluid in each of the heat-exchange portions.

Such a heat exchanger is particularly advantageous in that it offers the possibility, according to the cooling needs of the equipment of each high-temperature and low-temperature circuit, of modulating the necessary heat-exchange surface area while maintaining a minimal space requirement, the fluid distribution means not being incorporated into the collector boxes.

A further object of the invention is a system for managing the thermal energy developed by a motor vehicle engine.

Other advantages and features of the invention will appear below on reading the following description, which is illustrative and nonlimiting, of the figures of the appended drawings, in which:

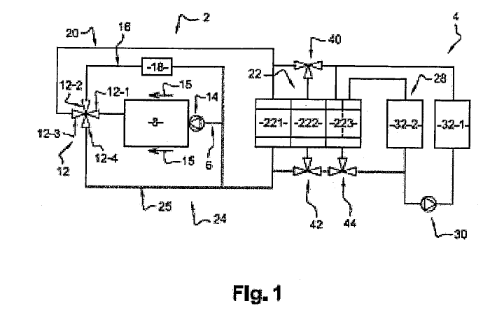

FIG. 1 represents schematically a system for managing the thermal energy developed by a heat engine of a motor vehicle according to the present invention;

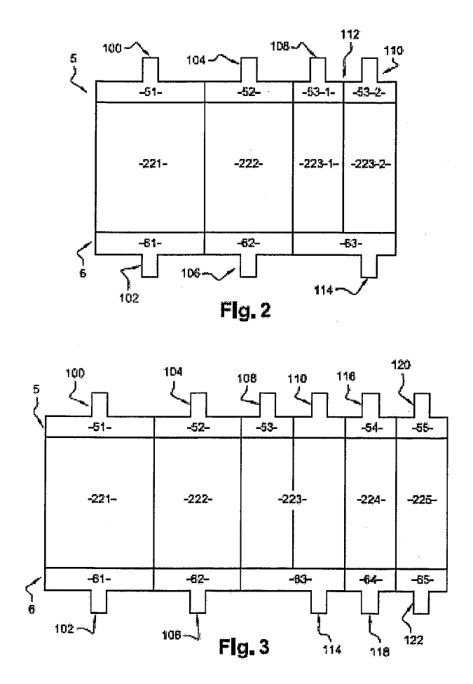

FIG. 2 is a schematic view in perspective of a heat exchanger according to a first embodiment; and

FIG. 3 is a schematic view in perspective of a heat exchanger according to a second embodiment.

As illustrated in FIG. 1, the system for managing the thermal energy developed by a heat engine of a motor vehicle comprises a high-temperature circuit 2 furnished, for example, with an engine inlet pipe 6 connected to the heat engine 8 of the vehicle and an engine outlet pipe 10 connected to a four-way valve 12. A mechanical or electric pump 14 circulates a coolant fluid through the engine block, as schematized by the arrows 15. The high-temperature cooling circuit also comprises a heating pipe 16 on which a space heater 18 is mounted. The circulation pump 14 also circulates the coolant fluid in the space heater 18.

From the four-way valve 12, the coolant fluid can also follow a high-temperature radiator pipe 20 connected to a heat exchanger 22 according to the present invention and explained in detail below. The heat exchanger 22 is traversed by the coolant fluid. Finally, a branch pipe or short-circuit pipe 24 allows the coolant fluid to return to the engine 8 without having traversed the heat exchanger 22, as schematized by the arrow 25.

The four-way valve 12 comprises an inlet way designated by the reference 12-1 and three outlet ways, respectively a way 12-2 connected to the heating pipe 16, a way 12-3 connected to the high-temperature radiator pipe 20 and a way 12-4 connected to the short-circuit pipe 24.

The system for managing the thermal energy developed by a motor vehicle heat engine according to the invention also comprises a secondary or low-temperature cooling circuit 4 furnished, for example, with a low-temperature radiator pipe 28 to which is mounted an electric low-temperature circulation pump 30 and one or more heat exchangers 32-1 or 32-2. The example shown depicts two heat exchangers 32-1 and 32-2 designed to cool or if necessary to heat equipment of the vehicle. The heat exchangers 32 may be, for example, a condenser of an air-conditioning circuit and a turbocharge air cooler. They are cooled by heat exchange with the low-temperature coolant fluid which circulates in the low-temperature cooling circuit 4. The low-temperature fluid is also cooled in the heat exchanger 22.

The system for managing the developed thermal energy also comprises at least a first distribution means 40 for allocating the fluid originating from the high-temperature circuit and/or low-temperature circuit in a section called the allocatable section or third portion 222 of the heat exchanger 22. The first distribution means 40 is provided on the outside of the heat exchanger 22.

A second distribution means 42 for its part makes it possible to direct or allocate the fluid leaving the third portion 222 of the heat exchanger 22 and traveling to the high-temperature loop 2 or the low-temperature lop 4. Here also, the second distribution means 42 is provided on the outside of the heat exchanger 22.

A particular embodiment of the invention proposes having only one of the two distribution means 40 or 42.

A third distribution means 44 may also be used to redirect some or all of the fluid leaving the third portion 222 of the heat exchanger 22 and traveling to a second portion 223 of the heat exchanger 22, this third distribution means therefore allows a connection between the third portion and the second portion. Therefore, the cooling fluid will be cooled to a lower temperature level by passing through the second portion 223 of the heat exchanger 22.

The distribution means 40 and 42 may or may not be actuated at the same time. Similarly, the distribution means 40 and 44 may be coordinated according to the cooling requirements of the high-temperature circuit 2 and the low-temperature circuit 4.

These distribution means 40; 42 and 44 are in this instance valves actuated by control means (not shown) which receive information from sensors (not shown) placed at appropriate locations in the high-temperature cooling circuit 2 and the low-temperature cooling circuit 4. This information may, for example, be the water temperature at the outlet of the engine 8 in the pipe 10, the engine rotation speed, the thermal power discharged by the engine into the high-temperature cooling circuit. The control means may take account of one or more of these items of information.

The distribution of the fluid leaving the high-temperature circuit 3 and the low-temperature circuit 4 in the allocatable portion 222 of the heat exchanger 22 is controlled according to the cooling needs of the high-temperature circuit 2 and the low-temperature circuit 4.

Therefore, when the engine 8 operates at low load or at partial load, these cooling means are not very great and the majority of the high-temperature cooling fluid circulates through the short-circuit pipe 24. In these conditions, the exchange surface area of the allocatable section 222 of the heat exchanger 22 can be recovered for cooling the low-temperature equipment schematized by the heat exchanger 32. This improves their performance, for example the thermal performance of the air-conditioning circuit, by proposing a condenser the cooling capacity of which is greater.

When the engine operates at high load, it is, by contrast, necessary to circulate a considerable quantity of coolant fluid through the engine block to extract the discharged thermal power. In these conditions, the exchange surface area of the allocatable section 222 of the heat exchanger 22 is used for cooling the engine.

FIG. 2 represents a heat exchanger according to the invention. This heat exchanger 22 comprises a heat-exchange cluster consisting, for example, of a stack of tubes and fins. The tubes (not shown) are all identical and are parallel with one another. A cooling fluid circulates therein which exchanges heat with an external environment, for example the atmospheric air.

The tubes of the heat-exchange module 22 are connected, at each of their two ends, to collector boxes, namely respectively an inlet collector box for the coolant fluid and an outlet box for the outlet of the coolant fluid.

In this embodiment, the heat-exchange surface area consists of three distinct sections: a high-temperature heat-exchange section or first portion 221, a low-temperature heat-exchange section or second portion 223 and an allocatable section or third portion 222 placed between the sections 221 and 223.

The first portion 221 is specifically for cooling the fluid circulating in the high-temperature circuit 2 or first heat-exchange loop. The second portion is specifically for cooling the fluid circulating in the secondary cooling circuit 4 or second heat-exchange loop. The third portion, depending on requirements, is specifically for cooling the first or the second heat-exchange loop.

It will be noted that the fluid circulating in the first heat-exchange loop 2 and second heat-exchange loop 4 is one and the same fluid, for example, water with added glycol.

The sections 221; 222 and 223 are fixed. In other words, they comprise a determined and fixed number of heat-exchange tubes of the heat exchanger 22.

According to the illustrated embodiment, the tubes of the first portion 221 open at one end into a high-temperature inlet collector 51 and, at the other end, into a high-temperature outlet collector 61.

The tubes of the third portion 222 are connected, at their inlet end, to an allocatable inlet collector 52 and, at their outlet end, to an allocatable collector 62.

The first, second and third portions each comprise at least one inlet and at least one outlet for the fluid.

Therefore, the inlet collectors 51 and 52 comprise respectively nozzles 100 and 104 for the inlet of said fluid and the outlet collectors 61 and 62 comprise respectively nozzles 102 and 106 for the outlet of said fluid.

The high-temperature cooling fluid enters the inlet collector 51 and leaves the outlet collector 61, after having traversed the high-temperature heat-exchange section 221. In the same manner, the high- or low-temperature cooling fluid enters the allocatable inlet collector 52 and leaves the allocatable outlet collector after having traversed the allocatable exchange section 222.

The tubes of the second portion 223 are connected respectively to a collector 53 and to an intermediate collector 63. A partition 112 makes it possible to divide the collector 53 into two portions, namely a portion 53-1 for the cooling fluid to enter the second portion and a portion 53-2 for the outlet of this same fluid. Therefore, the cooling fluid has a circulation called a two-pass circulation in the second portion 223. In other words, the low-temperature cooling fluid enters the inlet collector 53-1 via an inlet nozzle 108 and then circulates in the first heat-exchange section or the first pass 223-1 of the second portion 223. The cooling fluid then makes an about turn in the intermediate collector 63 and circulates in the second heat-exchange section or second pass 223-2 of the second portion 223. Finally, the fluid leaves the outlet collector box 53-2 via the cooling fluid outlet nozzle 110.

It should be noted that the intermediate collector 63 comprises a second cooling-fluid inlet 114. In this example, the second inlet is situated at the second heat-exchange section 223-2 of the second portion 223. This second inlet 114 makes it possible to circulate, if necessary, the cooling fluid leaving the third portion 222 in the second heat-exchange section 223-2 of the second portion 223 in order to obtain the desired temperature level of the cooling fluid. Therefore, the first pass 223-1 and second pass 223-2 each comprise an inlet for the cooling fluid.

The heat exchanger 22 according to the invention comprises two collector boxes 5 and 6 into which the respective ends of each tube lead. The collector boxes 5 and 6 are furnished with partitions defining respectively the collectors 51; 52; 53-1; 53-2; 61; 62; and 63.

FIG. 3 represents a heat exchanger according to a second embodiment of the invention. The heat-exchange surface consists, in this instance, of five distinct sections, namely: a high-temperature heat-exchange section or first portion 221, a second low-temperature heat-exchange section or second portion 223 and an allocatable section or third portion 222 placed between the sections 221 and 223. These three sections are identical to those described in the embodiment of FIG. 2.

In this embodiment, the heat exchanger also comprises additional heat-exchange sections including one section called the “subcooling” section 224 and an “annex” section 225. Here also, the various heat-exchange sections 221; 222; 223; 224 and 225 are fixed.

The subcooling portion 224 is specifically for the cooling fluid circulating in the second heat-exchange loop 4. This portion also comprises an inlet and an outlet for the cooling fluid.

The subcooling section 224 comprises an inlet collector 54 furnished with a nozzle 116 and an outlet collector 64 furnished with a nozzle 118. This heat-exchange zone makes it possible to lower the temperature of some or all of the cooling fluid leaving the second heat-exchange zone 223. Thanks to this feature, the cooling fluid originating from the low-temperature loop may be cooled to at least two heat-exchange levels. It is then possible to more effectively cool the heat exchangers mounted on the low-temperature loop. Naturally, the cooling fluid may also be cooled to more than two heat-exchange levels by providing additional passes and corresponding outlets.

The portion 224 specifically for subcooling and the portion specifically for cooling the second heat-exchange loop 4 communicate with one another. This communication may be obtained by various communication means. The communication means may notably be situated on the outside of the collector boxes and in this case may be valves. Another embodiment proposes that this communication is obtained by means of at least one through-orifice and communication means of said orifice, the through-orifice corresponding in this case to the inlet of the portion specifically for subcooling.

The flow of cooling fluid inside this section or portion specifically for subcooling will be weaker than the flow passing through the low-temperature portion 223 of the heat exchanger 22.

This cooling system may notably be applied to the cooling of a condenser of an air-conditioning circuit which comprises a condensation stage and a subcooling stage for the refrigerant. The condensation stage will then be cooled by cooling liquid originating from the second heat-exchange zone 223 and the subcooling stage will be cooled by cooling liquid originating from the subcooling section.

The heat exchanger 22 also comprises a fifth heat-exchange section 225, called the annex portion. This portion is designed for cooling another fluid such as, for example, transmission oil or automatic gearbox oil.

The tubes of this portion 225 are identical to the tubes of the other four portions and are also connected to an inlet collector 55 and to an outlet collector 65. Each collector comprises an inlet nozzle 120 or outlet nozzle 122 for said other fluid.

The invention is not limited to the embodiments described above, only as examples, but it encompasses all the variants that those skilled in the art could envisage in the context of the following claims.

1. A heat exchanger comprising at least a first, a second and a third heat-exchange portions (221; 222; 223) situated substantially in one and the same plane, said exchanger allowing an independent circulation of fluid in each of said exchange portions (221; 222; 223).

2. The heat exchanger as claimed in claim 1, wherein said first exchange portion (221) is for cooling a fluid of a first heat-exchange loop (2), said second portion (223) is for cooling a fluid of a second heat-exchange loop (4), and said third portion (222) is for cooling said first or the second heat-exchange loop (2; 4), and wherein the fluid circulating in said first heat-exchange loop (2) and said second heat-exchange loop (4) is one and the same fluid.

3. The heat exchanger as claimed in claim 1, wherein said first, second and third portions (221; 222; 223) each comprise at least one inlet (100; 104; 108; 114) and at least one outlet (102; 106; 110) for the fluid.

4. The heat exchanger as claimed in claim 3, wherein said second portion (223) allows a circulation of the fluid in two passes (223-1; 223-2), said first pass (223-1) and the second pass (223-2) each comprising one inlet (108; 114) for the fluid.

5. The heat exchanger as claimed in one of claims 3, further comprising another portion (224) for subcooling the fluid circulating in said second heat-exchange loop (4), said other portion for subcooling also comprising one inlet (116) and one outlet (118).

6. The heat exchanger as claimed in claim 5, wherein said other portion (224) for subcooling and said portion (223) cooling said second heat-exchange loop (4) communicate via at least one through-orifice and switching means, said through-orifice corresponding to the inlet of said portion for subcooling.

7. The heat exchanger as claimed in claim 1, further comprising at least one other portion (225) designed for the cooling of another fluid.

8. The heat exchanger as clamed in claim 1, comprising a heat-exchange cluster including a stack of tubes and fins, with said tubes being identical.

9. The heat exchanger as claimed in claim 1, wherein tubes open into collector boxes (5; 6), said collector boxes (5; 6) comprising at least one inlet (100; 104; 108; 114; 116; 120) and at least one outlet (102; 106; 118; 122) for each of said portions (221; 222; 223-1; 223-2; 224; 225).

10. A system for managing the thermal energy developed by a motor vehicle engine, comprising a high-temperature cooling circuit (2) comprising a high-temperature radiator in order to cool the vehicle engine and a low-temperature cooling circuit (4) comprising a low-temperature radiator in order to cool the equipment of the vehicle, characterized in that said high- and low-temperature radiators form part of said heat exchanger (22) as claimed in claim 1.

11. The thermal-energy-management system as claimed in claim 10, wherein a first distribution means (40) is provided on the outside of said heat exchanger (22) in order to allocate the fluid originating from said first heat-exchange loop (2) or from said second heat-exchange loop (4) to said third portion (222).

12. The thermal-energy-management system as claimed in claim 10, wherein a second distribution means (42) is provided on the outside of said heat exchanger (22) in order to allocate the fluid leaving said third portion (222) to said first heat-exchange loop (2) or to said second heat-exchange loop (4).

13. The thermal-energy-management system as claimed in claim 10, wherein a third distribution means (44) allows a connection between said third portion (222) and said second portion (223).

14. The thermal-energy-management system as claimed in claim 10, wherein said distribution means (40; 42; 44) are one or more valves.

15. The thermal-energy-management system as claimed in claim 10, wherein
said high-temperature cooling circuit (2) comprises a main network fitted with a main pump (14) in order to circulate a fluid through the heat engine (8) and said main network also comprises a short-circuit pipe (24) and a heating pipe (16) comprising a space heater (18),
and wherein said low-temperature cooling circuit (4) comprises a secondary network including a secondary pump (30) and at least one equipment heat exchanger (32),
and said main network and said secondary network are connected by interconnection means which make it possible to circulate the fluid in a controlled manner between said main network and said secondary network or to prevent this circulation, depending on at least the load state of the heat engine (8).

16. The heat exchanger as claimed in claim 2, wherein said first, second and third portions (221; 222; 223) each comprise at least one inlet (100; 104; 108; 114) and at least one outlet (102; 106; 110) for the fluid.

17. The heat exchanger as claimed in one of claims 4, further comprising another portion (224) for subcooling the fluid circulating in said second heat-exchange loop (4), said other portion for subcooling also comprising one inlet (116) and one outlet (118).
